(19) United States
(12) Patent Application Publication
(10) Pub. No.: US 2026/0370972 A1
(43) Pub. Date: Nov. 19, 2026

(54) CURRENT-CONTROLLED VOLTAGE REGULATOR CIRCUIT OF IMAGE SENSING DEVICE

(71) Applicant: Samsung Electronics Co., Ltd., Suwon-si (KR)

(72) Inventors: Dong Young SONG, Suwon-si (KR); Ji Un JEONG, Suwon-si (KR)

(21) Appl. No.: 19/676,961

(22) Filed: May 14, 2026

(30) Foreign Application Priority Data
May 14, 2025 (KR) 10-2025-0062304

(51) Int. Cl. H04N 25/709; H04N 25/40

(52) U.S. Cl. CPC H04N 25/709; H04N 25/40

(57) ABSTRACT

A current-controlled voltage regulator circuit of an image sensor includes a low-power module that is enabled in a low-power mode and outputs a first output voltage, and a high-speed module that is enabled in a high-speed mode in response to an enable state of a high-speed enable signal, and outputs a second output voltage based on a high-speed driver enable signal. The current-controlled voltage regulator circuit boosts a high-speed static current of the high-speed module while the high-speed enable signal is enabled and before the high-speed driver enable signal is enabled, and generates the second output voltage based on the boosted high-speed static current when the high-speed driver enable signal is enabled.

### CROSS-REFERENCE TO RELATED APPLICATION

This application claims priority from Korean Patent Application No. 10-2025-0062304 filed on May 14, 2025 in the Korean Intellectual Property Office and all the benefits accruing therefrom under 35 U.S.C. 119, the contents of which in its entirety are herein incorporated by reference.

### BACKGROUND

### Technical Field

The present disclosure relates to a current-controlled voltage regulator circuit used in an image sensing device.

### Description of the Related Art

An image sensor converts optical images into electrical signals. Recently, with the development of the computer industry and the communication industry, the demand for image sensors with improved performance has been increasing in various fields such as digital cameras, digital video cameras, smartphones, and portable computers.

An interface module of an image sensing device includes a current-controlled voltage regulator circuit that operates in a low-power control mode and a high-speed burst mode, for example, a dual mode. The current-controlled voltage regulator circuit generates and outputs an output voltage Vout by receiving an input voltage Vin.

When transmitting image data, the interface module enters the high-speed burst mode from the low-power control mode and transmits data. However, in order that the interface module switches to the high-speed burst mode, when a circuit wakeup time and the time required for output stabilization are longer than a mode switching period, communication errors such as errors due to clock jitter problems of a preamble period, synchronization pattern recognition errors, and HS packet data transmission errors may occur. Additionally, when switching from the low-power control mode to the high-speed burst mode, the voltage regulator circuit may cause voltage fluctuation in the output voltage due to current loading.

### BRIEF SUMMARY

An object of the present disclosure is to provide a current-controlled voltage regulator circuit of an image sensing device that stably provides an output voltage during mode switching.

Another object of the present disclosure is to provide a current-controlled voltage regulator circuit of an image sensing device that reduces power waste through static current control of a dynamic disable period.

Other object of the present disclosure is to provide a current-controlled voltage regulator circuit of an image sensing device that may eliminate timing constraints related to a transmitter by improving characteristics of an I/O output.

According to an example embodiment, a current-controlled voltage regulator circuit of an image sensor includes a low-power module that is enabled in a low-power mode and outputs a first output voltage, and a high-speed module that is enabled in a high-speed mode in response to an enable state of a high-speed enable signal, and outputs a second output voltage based on a high-speed driver enable signal. The current-controlled voltage regulator circuit boosts a high-speed static current of the high-speed module while the high-speed enable signal is enabled and before the high-speed driver enable signal is enabled, and generates the second output voltage based on the boosted high-speed static current when the high-speed driver enable signal is enabled.

According to an example embodiment, a current-controlled voltage regulator circuit of an image sensor, the current-controlled voltage regulator circuit comprising: an operational amplifier configured to receive a reference voltage and a feedback signal; a pass transistor comprising a gate that is connected to an output of the operational amplifier, wherein the pass transistor is connected to a power voltage terminal, and to a first node; a distribution resistor string connected between the first node and a ground node; a first variable resistor string connected in parallel with the distribution resistor string and configured to conduct a current between the first node and the ground node when a first control signal is enabled; a driver circuit connected to the first node and configured to generate an output voltage based on a static current of the first node; and a timing controller configured to generate the first control signal and a second control signal, wherein the feedback signal is a signal of a common node connected to a first intermediate node of the distribution resistor string and a second intermediate node of the variable resistor string, and wherein the timing controller is configured to boost the static current of the first node by enabling the first control signal while a high-speed enable signal is enabled and before a high-speed driver enable signal is enabled.

According to an example embodiment, an image sensing device comprises a pixel array including a plurality of pixels to output a pixel value sensed from each of the pixels; an ADC circuit configured to perform analog-to-digital conversion for the pixel value; a buffer configured to store the analog-to-digital converted pixel value; and an input/output circuit including a current-controlled voltage regulator circuit, configured to generate an output voltage by comparing a reference voltage with a feedback signal, and configured to generate image data with the output voltage applied to a raw image including the analog-to-digital converted pixel value stored in the buffer to output the image data, wherein a high-speed static current of the current-controlled voltage regulator circuit is configured to be boosted while a high-speed enable signal is enabled and before a high-speed driver enable signal is enabled, and a high-speed regulating voltage generated by the current-controlled voltage regulator circuit is output as the output voltage based on the boosted high-speed static current when the high-speed driver enable signal is enabled.

The objects of the present disclosure are not limited to those mentioned above and additional objects of the present disclosure, which are not mentioned herein, will be clearly understood by those skilled in the art from the following description of the present disclosure.

### BRIEF DESCRIPTION OF THE DRAWINGS

FIG. 1 is a diagram illustrating an image sensing device according to some embodiments of the present disclosure.

FIG. 2 is a block diagram illustrating a current-controlled voltage regulator circuit according to one embodiment of the present disclosure.

FIG. 3 is a diagram illustrating a current-controlled voltage regulator circuit according to another embodiment of the present disclosure.

FIG. 4 is a diagram illustrating a current-controlled voltage regulator circuit according to one embodiment of the present disclosure.

FIG. 5 is an operation timing diagram of a current-controlled voltage regulator circuit according to the first embodiment of the present disclosure.

FIG. 6 is an operation timing diagram of a current-controlled voltage regulator circuit according to the second embodiment of the present disclosure.

FIG. 7 is an operation timing diagram of a current-controlled voltage regulator circuit according to the third embodiment of the present disclosure.

FIG. 8 is an operation timing diagram of a current-controlled voltage regulator circuit according to the fourth embodiment of the present disclosure.

FIG. 9 is an operation timing diagram of a current-controlled voltage regulator circuit according to the fifth embodiment of the present disclosure.

FIG. 10 is an operation timing diagram of a current-controlled voltage regulator circuit according to the sixth embodiment of the present disclosure.

FIG. 11 is a diagram illustrating a voltage graph according to operations of a current-controlled voltage regulator circuit of the present disclosure and a current-controlled voltage regulator circuit of comparative examples.

### DETAILED DESCRIPTION OF THE DISCLOSURE

Hereinafter, various embodiments of the present disclosure will be described with reference to the accompanying drawings. The present application may, however, be embodied in many different forms and should not be construed as limited to the example embodiments set forth herein. These example embodiments are just that – examples – and many implementations and variations are possible that do not require the details provided herein. It should also be emphasized that the disclosure provides details of alternative examples, but such listing of alternatives is not exhaustive. Furthermore, any consistency of detail between various examples should not be interpreted as requiring such detail – it is impracticable to list every possible variation for every feature described herein.

As used herein, ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be referenced elsewhere without an ordinal number or with a different ordinal number (e.g., “second” in the specification or another claim).

As used herein, components described as being “electrically connected” are configured such that an electrical signal can be transferred from one component to the other (although such electrical signal may be attenuated in strength as it is transferred and may be selectively transferred). Moreover, components that are “directly electrically connected” form a common electrical node through electrical connections by one or more conductors, such as, for example, wires, pads, internal electrical lines, through vias, etc. As such, directly electrically connected components do not include components electrically connected through active elements, such as transistors or diodes.

In embodiments, a controller (e.g., camera controller 102) may be provided, and the controller may be a processor (i.e., a hardware circuit), such as a microprocessor, a CPU (Central Processing Unit), a GPU (graphics processor), a digital signal processor (DSP), a field- programmable gate array (FPGA), etc., and may be part of a computer. Such a controller may be formed by several interconnected controllers and may be configured by software.

The controller may be a computer (or several interconnected computers) and may include, for example, one or more processors configured by software, such as a CPU (Central Processing Unit), GPU (graphics processor), controller, etc. The computer may be a general purpose computer or may be dedicated hardware or firmware (e.g., an electronic or optical circuit, such as application-specific hardware, such as, for example, a digital signal processor (DSP) or a field- programmable gate array (FPGA)). A computer may be configured from several interconnected computers. Each functional module (or unit) described herein may comprise a separate computer, or some or all of the functional module (or unit) may be comprised of and share the hardware of the same computer. Connections and interactions between the units described herein may be hardwired and/or in the form of data (e.g., as data stored in and retrieved from memory of the computer, such as a register, buffer, cache, storage drive, etc., such as part of an application programming interface (API)). The functional modules (or units) of the controller may each correspond to a separate segment or segments of software (e.g., a subroutine) which configure the computer of the controller, and/or may correspond to segment(s) of software that also correspond to one or more other functional modules (or units) described herein (e.g., the functional modules (or units) may share certain segment(s) of software or be embodied by the same segment(s) of software). As is understood, “software” refers to prescribed rules to operate a computer, such as code or script. Storage (e.g., storage device) may comprise conventional memory of a computer, such as a hard drive (which may be a solid state drive, DRAM, NAND flash memory, etc.). An operation unit may comprise a conventional computer user interface and include convention input devices, such as a keyboard, mouse, trackpad, touchscreen, etc.

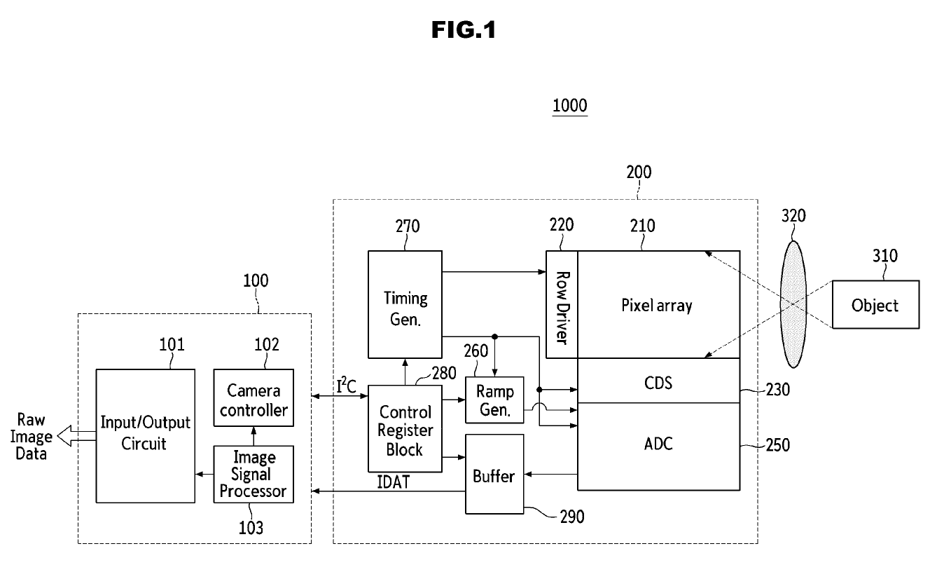

FIG. 1 is a diagram illustrating an image sensing device according to some embodiments of the present disclosure.

Referring to FIG. 1, according to some embodiments, an image sensing device 1000 may be implemented as a portable electronic device, such as a digital camera, a camcorder, a mobile phone, a smart phone, a tablet personal computer (PC), a personal digital assistant (PDA), a mobile Internet device (MID), a wearable computer, an Internet of Things (IoT) device, or an Internet of Everything (IoE) device.

According to some embodiments, the image sensing device 1000 may include a digital signal processor (DSP) 100 and an image sensor 200. The image sensor 200 may be, for example, a CMOS image sensor.

The image sensor 200 includes a pixel array 210, a row driver 220, a correlated double sampling (CDS) block 230, an analog digital converter (ADC) 250, a ramp generator 260, a timing generator 270, a control register block 280, and a buffer 290.

The image sensor 200 may sense an object 310 photographed through a lens 320 under control of a camera controller 102. According to some embodiments, the image sensor 200 may output a binned image IDAT to the DSP 100 by performing analog binning for pixel data generated in the pixel array 210 through the ADC block 250 and the buffer 290.

The DSP 100 includes a camera controller 102, an image signal processor ISP 103, and an interface (I/F) circuit 101 (e.g., input/output circuit in FIG. 1).

The camera controller 102 controls an operation of the control register block 280. The camera controller 102 may control an operation of the image sensor 200, for example, the control register block 280, by using an inter-integrated circuit (I2C), but the present disclosure is not limited thereto.

The ISP 103 receives image data output from the buffer 290, processes the received image data so that the image data is viewable, and outputs the processed image data to a display unit through the input/output circuit 101.

According to some embodiments, the ISP 103 may process the image data IDAT output from the image sensor 200. The ISP 103 may output the digital binned image to the outside as a final binned image.

The pixel array 210 includes a plurality of pixels arranged in a matrix form. Each of the plurality of pixels includes a photo-sensing element (or a photoelectric conversion element or a photodiode) and a readout circuit that outputs a pixel signal corresponding to charges generated by the photo-sensing element, for example, an analog signal. The photo-sensing element may be implemented as, for example, a photodiode or a pinned photodiode.

The row driver 220 may facilitate the operation of each of the plurality of pixels. For example, the row driver 220 may drive the pixels implemented in the pixel array 210 in units of rows. For example, the row driver 220 may generate control signals capable of controlling an operation of the plurality of pixels included in each of a plurality of rows.

The pixel signal output from each of the plurality of pixels is transmitted to the CDS block 230 in accordance with the control signals.

The CDS block 230 includes a plurality of CDS circuits. Each of the plurality of CDS circuits may perform correlated double sampling for pixel values respectively output from a plurality of column lines implemented in the pixel array 210 in response to at least one switch signal output from the timing generator 270, and may output a plurality of comparison signals by comparing the correlated double sampled pixel value with a ramp signal output from the ramp generator 260.

The ADC block 250 may convert the plurality of comparison signals into digital signals and output the plurality of digital signals to the buffer 290.

The ramp generator 260 outputs a ramp signal Vramp to the CDS block 230. The ramp signal Vramp is ramped to be compared with a reset signal Vrst from a reference level, increased to the reference level and ramped again from the reference level to be compared with an image signal.

The timing generator 270 may control the operations of the row driver 220, the ADC block 250, the CDS block 230 and the ramp generator 260 under the control of the control register block 280.

The control register block 280 controls the operations of the timing generator 270, the ramp generator 260 and the buffer 290 under the control of the DSP 100.

The buffer 290 may transmit pixel data corresponding to the plurality of digital signals (Pixel Array ADC output) output from the ADC block 250 to the DSP 100. The pixel data output from the pixel array 210 through the CDS block 230 and the ADC block 250 may be a Bayer image configured in a Bayer format.

According to some embodiments, the ISP 103 may receive and process a raw image from the image sensor 200 to output an output image. For example, the ISP 103 may operate by being divided into pre-ISP (hereinafter, referred to as pre-processing) and ISP chain (hereinafter, referred to as post-processing).

The input/output circuit 101 outputs the output image of the ISP 103 to the outside. For example, the input/output circuit 101 may output the output image of the ISP 103 to a display device. For example, the input/output circuit 101 may output the output image of the ISP 103 to an application processor (AP). Alternatively, for example, the input/output circuit 101 may output the output image of the ISP 103 to a storage device.

According to some embodiments, the input/output circuit 101 may exchange data in accordance with a protocol defined in a mobile industry processor interface (MIPI) standard. According to some embodiments, the input/output circuit 101 may output the output image in a single-ended signal scheme without a separate clock signal lane, based on a C-PHY interface according to the MIPI standard.

When performing data communication with an external device (e.g., AP), the input/output circuit 101 transmits and receives data by switching from a low-power mode to a high-speed burst mode. In this case, it is assumed that a device for providing data is a master device and a device for receiving data is a slave device. When entering the high-speed burst mode between the two devices, an operation clock is restored for synchronization between the master device and the slave device during a preamble period, and a synchronization pattern is transmitted. When synchronization between the two devices is completed, the master device then transmits high-speed data (Packet). Post sequence may be transmitted after all high-speed data is transmitted.

When outputting an output image (for example, Raw image data) to the outside, the input/output circuit 101 switches from the low-power mode to the high-speed burst mode to output image data. For example, the input/output circuit 101 operates in the high-speed burst mode when outputting the output image, and operates in the low-power mode in other cases.

However, when an output voltage of the input/output circuit 101 (e.g., which is the master device) is unstable or a settle time of the output signal is delayed at the preamble period, clock recovery on the side of the slave device may not be properly performed within a preamble setting time predefined in the MIPI standard. When clock recovery is incomplete, a data error may occur in the output image data output from the input/output circuit 101. Therefore, performance of the voltage regulator circuit for supplying a power source of a transmitter in the input/output circuit 101 is important.

According to some embodiments, the input/output circuit 101 may include a dual-mode current-controlled voltage regulator circuit (hereinafter, referred to as a voltage regulator circuit).

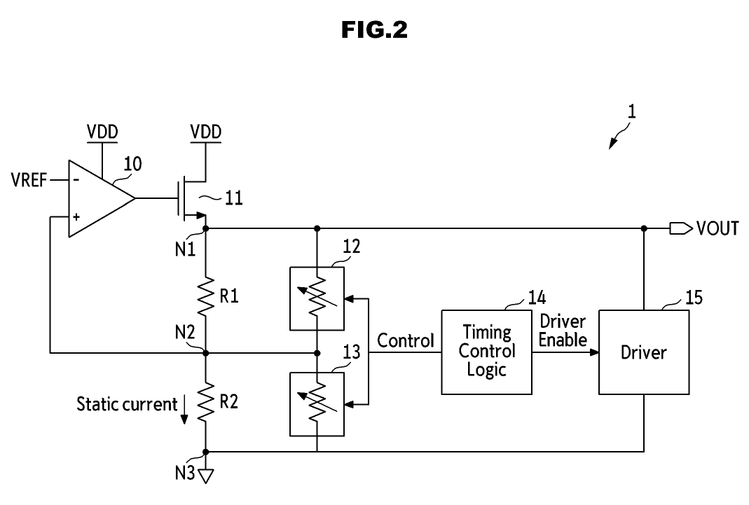

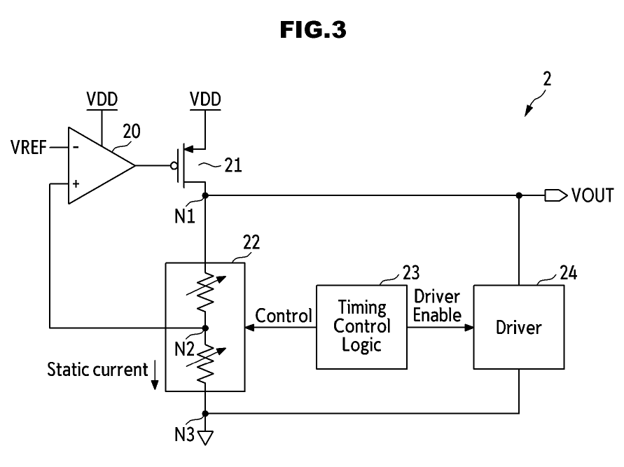

For example, the voltage regulator circuit may include a high-speed module and a low-power module. The voltage regulator circuit may operate by selectively enabling the high-speed module or the low-power module based on a high-speed enable signal. When the high-speed enable signal is enabled, the voltage regulator circuit operates such that the high-speed module is turned on (or enabled) to output a first voltage in a high-speed mode and the low-power module is turned off (or disabled). When the high-speed enable signal is disabled, the voltage regulator circuit operates such that the high-speed module is turned off and the low-power module is turned on to output a second voltage in the low-power mode. The high-speed module and the low-power module may adjust the output voltage by using a feedback loop connected to an output terminal of the voltage regulator circuit. Various embodiments of the high-speed module and the low-power module circuit will be described with reference to FIGS. 2 and 3.

FIG. 2 is a block diagram illustrating a current-controlled voltage regulator circuit according to one embodiment of the present disclosure.

According to some embodiments, each of the high-speed module and the low-power module of the voltage regulator circuit may be implemented as the circuit shown in FIG. 2.

A voltage regulator circuit 1 according to one embodiment includes an operational amplifier 10, a pass transistor 11, a first resistor R1, a second resistor R2, a first variable resistor 12, a second variable resistor 13, a timing control logic 14, and an output driver 15.

The operational amplifier 10 compares a reference voltage VREF with a feedback signal provided through a node N2 and outputs the compared result. For example, the reference voltage VREF may be supplied to the inverting input (-) terminal of the operational amplifier 10, the node N2 may be connected to the non-inverting input (+) terminal of the operational amplifier 10, and the pass transistor 11 may be connected to the output terminal of the operational amplifier 10. The operational amplifier 10 outputs a comparison signal obtained by subtracting the reference voltage VREF from the feedback signal.

The pass transistor 11 is an N-type transistor, in which a gate is connected to an output terminal of the operational amplifier 10, a first terminal (or source terminal) is connected to the node N1, and a second terminal (or drain terminal) is connected to a supply node of a power supply voltage VDD. The pass transistor 11 generates an output voltage VOUT of the node N1 by allowing a static current corresponding to the comparison signal to flow from the power supply voltage VDD to a first voltage distribution path from node N1 to node N3.

The first resistor R1 and the second resistor R2 are connected in series between the node N1 and a node N3 and may form the first voltage distribution path. The first resistor R1 is connected between the node N1 and a node N2, and the second resistor R2 is connected between the node N2 and the node N3.

The first variable resistor 12 and the second variable resistor 13 are connected in series between the node N1 and the node N3 and may form a second voltage distribution path. The second voltage distribution path and the first voltage distribution path are connected in parallel between the node N1 and the node N3. The first variable resistor 12 is connected between the node N1 and the node N2, and the second variable resistor 13 is connected between the node N2 and the node N3. A resistance value of the first variable resistor 12 may vary depending on a first control signal of the timing control logic 14, and a resistance value of the second variable resistor 13 may vary depending on a second control signal of the timing control logic 14. According to some embodiments, the timing control logic 14 may provide the first control signal to the first variable resistor 12 and the second control signal to the second variable resistor 13 through a physically separated path. According to some embodiments, the timing control logic 14 may provide one control signal as a first control signal and a second control signal to the first variable resistor 12 and the second variable resistor 13 through one path, respectively.

The feedback signal is a signal obtained by dividing the output voltage VOUT by the resistors of the first voltage distribution path and the second voltage distribution path. For example, the feedback signal may be a signal divided by considering both a first ratio of the first resistor R1 and the second resistor R2 of the first voltage distribution path and a second ratio of the first variable resistor 12 and the second variable resistor 13 of the second voltage distribution path. The timing controller 14 may control the feedback signal by controlling a change in ratio of the first variable resistor 12 and the second variable resistor 13, so that the output voltage VOUT may be stably output. The feedback signal may be provided to the non-inverting input (+) terminal of the operational amplifier 10 due to node N2 being connected to the non-inverting input (+) terminal.

The output driver 15 is connected between the node N1 and the node N3 to drive a voltage of the node N1, thereby outputting the output voltage VOUT to the output terminal of the voltage regulator circuit 1.

FIG. 3 is a diagram illustrating a current-controlled voltage regulator circuit according to another embodiment of the present disclosure.

According to some embodiments, each of the high-speed module and the low-power module of the voltage regulator circuit may be implemented as the circuit shown in FIG. 3.

A voltage regulator circuit 2 according to one embodiment includes an operational amplifier 20, a pass transistor 21, a distribution variable resistor 22, a timing control logic 23, and an output driver 24.

The operational amplifier 20 compares a reference voltage VREF with a feedback signal provided through the node N2 and outputs the compared result. For example, the reference voltage VREF may be supplied to the inverting input (-) terminal of the operational amplifier 20, the node N2 may be connected to the non-inverting input (+) terminal of the operational amplifier 20, and the pass transistor 21 may be connected to the output terminal of the operational amplifier 20. The operational amplifier 20 outputs a comparison signal obtained by subtracting the reference voltage VREF from the feedback signal.

The pass transistor 21 is a P-type transistor, in which a gate is connected to an output terminal of the operational amplifier 20, a first terminal (drain terminal) is connected to the node N1, and a second terminal (source terminal) is connected to the supply node of the power supply voltage VDD. The pass transistor 21 generates the output voltage VOUT of the node N1 by allowing a static current corresponding to the comparison signal to flow from the power supply voltage VDD to the distribution variable resistor 22.

The distribution variable resistor 22 may form a voltage distribution path, and a plurality of variable resistor strings are connected between the node N1 and the node N3. A resistance value of the distribution variable resistor 22 may vary depending on a control signal of the timing control logic 23.

The timing control logic 23 adjusts the resistance value of the distribution variable resistor 22 to change magnitudes of the feedback signal and a static current, which are input to the operational amplifier 20. For example, the node N2 is a distribution node in the distribution variable resistor 22, and may be, for example, any one node selected by the timing control logic 23 in the variable resistor string.

The output driver 24 is connected between the node N1 and the node N3 to drive the voltage of the node N1, thereby outputting the output voltage VOUT to the output terminal of the voltage regulator circuit 1.

For example, the voltage regulator circuits 1 and 2 of FIGS. 2 and 3 adjust the static current and the feedback signal through timing control, thereby flexibly changing response characteristics of the output voltage according to external situations. The voltage regulator circuits 1 and 2 of FIGS. 2 and 3 adjust the response characteristics of the output voltage VOUT by closed-loop feedback control. The voltage regulator circuits 1 and 2 may stabilize a ripple phenomenon of the output voltage VOUT by opening the pass transistors 11 and 21 more at the low output voltage VOUT, and opening the pass transistors 11 and 21 less at the high output voltage VOUT, and at the same time may shorten the preamble time at which the output voltage VOUT is stabilized by adjusting the static current through timing control.

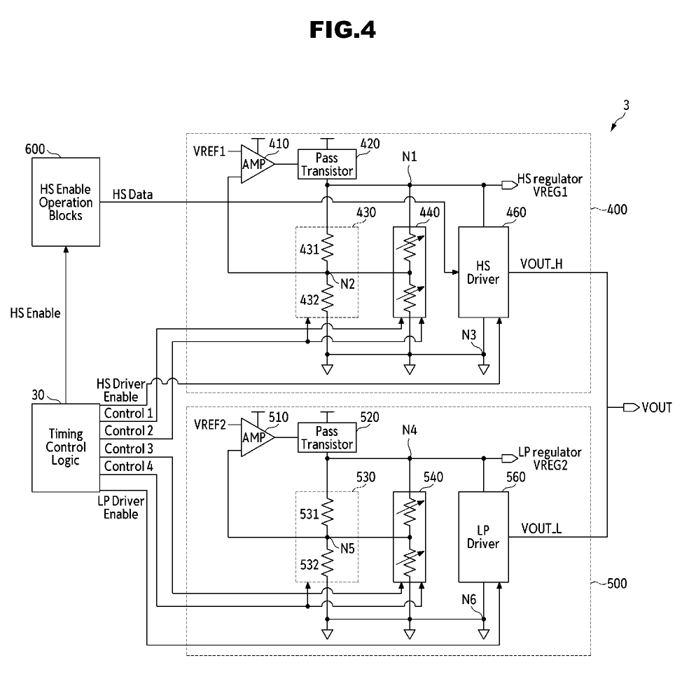

FIG. 4 is a diagram illustrating a current-controlled voltage regulator circuit according to one embodiment of the present disclosure.

Referring to FIG. 4, a voltage regulator 3 according to some embodiments includes a high-speed module 400, a low-power module 500, a HS enable operation block 600 and a timing control logic 30. The high-speed module 400 and the low-power module 500 are illustrated as the embodiment of the voltage regulator circuit of FIG. 3, but may be implemented as the voltage regulator circuit of FIG. 2 in accordance with another embodiment. In embodiments, the low-power mode may be a standby mode in which an image is not being captured and/or output to a memory from the image sensor is not occurring, while the high-speed mode may be used when an image is being output from an image sensor or processor to a memory.

The HS enable operation block 600 generates a high-speed data HS Data in response to an activation of a HS enable signal received from the timing control logic 30.

The high-speed module 400 includes an operational amplifier 410, a pass transistor 420, distribution resistor strings (430, 431 and 432), a first variable resistor string 440, and a high-speed driver 460.

The operational amplifier 410 includes a source/drain connected between a power voltage node and the node N1, receives a high-speed reference voltage VREF1 and a high-speed feedback signal of the node N2 as an input, and provides a first comparison signal to a gate of the pass transistor 420. The pass transistor 420 controls a high-speed regulating voltage HS regulator VREG1 output to the node N1 in accordance with the high-speed feedback signal of the node N2.

The distribution resistor string 430 and the first variable resistor string 440 are connected in parallel between the node N1 and the node N3. Intermediate nodes in the resistor strings of the distribution resistor string 430 and the first variable resistor string 440 are connected to each other as the nodes N2. For example, an intermediate node of the first resistor 431 and the second resistor 432 in the distribution resistor string is the node N2, which is directly connected to any one node in the first variable resistor string 440, and the node N2 is connected to the input of the operational amplifier 410. In particular, the node N2 may be connected between the first resistor 431 and the second resistor 432 which are connected in series. The node N2 may be connected between the two variable resistors of the first variable resistor string 440 which are connected in series. Although the first variable resistor string 440 is illustrated as comprising two variable resistors, with one variable resistor connected between the node N1 and the node N2 and another variable resistor connected between the node N2 and the node N3 in one embodiment, circuits in an equivalent range in which resistance values vary as distribution/division resistors according to various embodiments may also be included in the first variable resistor string 440.

The timing control logic 30 turns on and off the connection of the resistors included in the distribution resistor string 430 and the first variable resistor string 440 through first and second control signals control1 and control2 to adjust a total synthesis resistance value of the high-speed voltage module 400. According to Ohm’s law, as the number of resistors connected in parallel between the node N1 and the node N3 increases, the synthesis resistance value decreases, and a value of a static current flowing from the node N1 to the node N3 increases in inverse proportion to the synthesis resistance value. In embodiments, the first control signal control1 and the second control signal control2 cannot be simultaneously enabled. This is because that the first control signal control1 is for boosting a high-speed static current, and the second control signal control2 is for saving the high-speed static current. The timing control logic 30 may be connected to the distribution resistor string 430 to which the second control signal control2 may be transmitted, and the timing control logic 30 may be connected to the first variable resistor string 440 to which the first control signal control1 and the second control signal control 2 may be transmitted.

When the high-speed static current is boosted, the timing control logic 30 transmits the first control signal control1 to the first variable resistor string 440, and the first control signal control1 turns on the first variable resistor string 440 so that a total synthesis resistance value of the voltage regulator 3 decreases. Accordingly, the value of the static current flowing from the node N1 to the node N3 increases in accordance with the decreased total synthesis resistance value between nodes N1 and N3.

When the high-speed static current is saved, the timing control logic 30 transmits the second control signal control2 to the distribution resistor string 430 and the first variable resistor string 440, and the second control signal control2 turns off the first variable resistor string 440 and turns off at least one of the plurality of resistors included in the distribution resistor string 430 to increase the total synthesis resistance value of the voltage regulator 3. Accordingly, the value of the static current flowing from the node N1 to the node N3 decreases in accordance with the increased total synthesis resistance value.

Although each of the first control signal control1 and the second control signal control2 is shown as one signal in the shown embodiment, each of the first control signal control1 and the second control signal control2 may be implemented as a plurality of signals depending on the number of resistors included in the distribution resistor string 430 and the first variable resistor string 440.

According to various embodiments, the first control signal control1 implemented as a plurality of signals may be simultaneously activated or deactivated in accordance with one embodiment, or may be sequentially activated or deactivated in accordance with another embodiment. According to various embodiments, the second control signal control2 implemented as a plurality of signals may be simultaneously activated or deactivated in accordance with one embodiment, or may be sequentially activated or deactivated in accordance with another embodiment.

The timing control logic 30 activates the high-speed driver 460 through a high-speed driver enable signal HS Driver Enable. When the high-speed driver enable signal is activated, the high-speed driver 460 generates a high-speed voltage VOUT_H based on either the high-speed regulator voltage HS regulator VREG1 generated in the pass transistor 420 or the node N3 and outputs the high-speed voltage VOUT_H to the output terminal of the voltage regulator circuit 3. For example, when a high-speed driver enable signal HS Driver Enable is in a disable state, the high-speed voltage VOUT_H is output in a high-Z state based on the node N3, and when the high-speed driver enable signal HS Driver Enable is in an enable state, the high-speed voltage VOUT_H is output as the high-speed regulator voltage VREG1 based on the node N1. Accordingly, the high-speed driver enable signal HS Driver Enable may control the operation of the high-speed driver 460 and may allow for the selective output of the high-speed regulator voltage VREG1 by the high-speed driver 460. The high-speed driver enable signal HS Driver Enable may be transmitted to the high-speed driver 460, and the high-speed driver enable signal HS Driver Enable may be switched between the enable state and the disable state, thus causing the high-speed driver 460 to selectively output the high-Z state or the high-speed regulator voltage VREG1.

The low-power module 500 includes an operational amplifier 510, a pass transistor 520, distribution resistors (530, 531 and 532), a second variable resistor string 540, and a low-power driver 560.

The operational amplifier 510 includes a source/drain connected between the power voltage node and a node N4, and receives a low-power reference voltage VREF2 and a low-power feedback signal of a node N5 as an input to provide a second comparison signal to a gate of the pass transistor 520. The pass transistor 520 controls a low-power static current LP Regulator i_default flowing through the distribution resistor string 530 in accordance with the low-power feedback signal of the node N5.

The distribution resistor string 530 and the second variable resistor string 540 are connected in parallel between the node N4 and a node N6. Intermediate nodes in the resistor strings of the distribution resistor string 530 and the second variable resistor string 540 are connected to each other as the nodes N5. For example, an intermediate node of the third resistor 531 and the fourth resistor 532 in the distribution resistor string 530 is the node N5, which is directly connected to any one node in the second variable resistor string 540, and the node N5 is connected to the input of the operational amplifier 510. In particular, the node N5 may be connected between the third resistor 531 and the fourth resistor 532 which are connected in series. The node N5 may be connected between the two variable resistors of the second variable resistor string 540 which are connected in series. Although the second variable resistor string 540 is illustrated as comprising two variable resistors with one variable resistor connected between the node N4 and the node N5 and another variable resistor connected between the node N5 and the node N6 in one embodiment, circuits in an equivalent range in which resistance values vary as distribution/division resistors according to various embodiments may also be included in the second variable resistor string 540.

The timing control logic 30 turns on and off the connection of the resistors included in the distribution resistor string 530 and the second variable resistor string 540 through third and fourth control signals control3 and control4 to adjust a total synthesis resistance value of the low-power module 500.

According to Ohm’s law, as the number of resistors connected in parallel between the node N4 and the node N6 increases, the synthesis resistance value decreases, and a value of a static current flowing from the node N4 to the node N6 increases in inverse proportion to the synthesis resistance value. in some embodiments, the third control signal control3 and the fourth control signal control4 cannot be simultaneously enabled. This is because that the third control signal control3 is for boosting a low-power static current, and the fourth control signal control4 is for saving the low-power static current.

When the low-power static current is boosted, the timing control logic 30 transmits the third control signal control3 to the second variable resistor string 540, and the third control signal control3 turns on the second variable resistor string 540 so that a total synthesis resistance value of the low-power module 500 decreases. Accordingly, the value of the static current flowing from the node N4 to the node N6 increases in accordance with the decreased total synthesis resistance value between nodes N4 and N6.

When the low-power static current is saved, the timing control logic 30 transmits the fourth control signal control4 to the distribution resistor string 530 and the second variable resistor string 540, and the fourth control signal control4 turns off the second variable resistor string 540 and turns off at least one of the plurality of resistors included in the distribution resistor string 530 to increase the total synthesis resistance value of the voltage regulator 3. Accordingly, the value of the static current flowing from the node N4 to the node N6 decreases in accordance with the increased total synthesis resistance value.

Although each of the third control signal control3 and the fourth control signal control4 is shown as one signal in the shown embodiment, each of the third control signal control3 and the fourth control signal control4 may be implemented as a plurality of signals depending on the number of resistors included in the distribution resistor string 530 and the second variable resistor string 540.

According to various embodiments, the third control signal control3 implemented as a plurality of signals may be simultaneously activated or deactivated in accordance with one embodiment, or may be sequentially activated or deactivated in accordance with another embodiment. According to various embodiments, the fourth control signal control4 implemented as a plurality of signals may be simultaneously activated or deactivated in accordance with one embodiment, or may be sequentially activated or deactivated in accordance with another embodiment.

The timing control logic 30 activates the low-speed driver 560 through a low-speed driver enable signal LP Driver Enable. When the low-speed driver enable signal is activated, the low-power driver 560 generates a low-power voltage VOUT_L based on either a low-power regulator voltage LP regulator VREG2 of the node 4, which is generated in the pass transistor 520, or the node N6, and outputs the low-power voltage VOUT_L to the output terminal of the voltage regulator circuit 3.

For example, when a high-speed enable signal HS Enable is in a disable state, the low-power voltage VOUT_L is output as the low-power regulator voltage VREG2 based on the nodes N4 and N6, and when the high-speed enable signal HS Enable is in an enable state, the low-power voltage VOUT_L is output in a high-Z state.

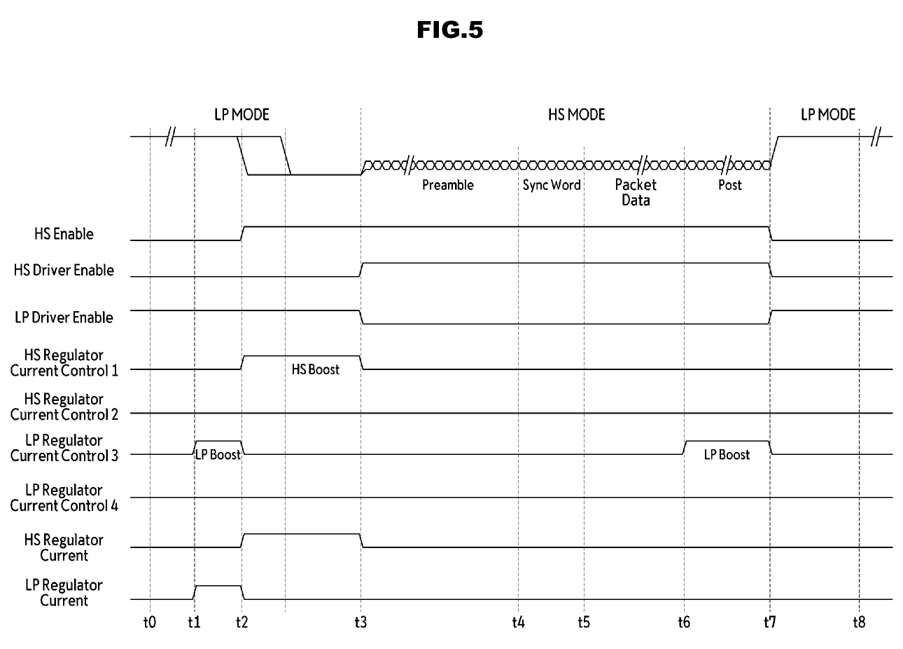

Only one of the high-speed module 400 and the low-power module 500 may be enabled based on the high-speed enable signal HS Enable to generate the high-speed voltage VOUT_H or the low-power voltage VOUT_L as the output signal of the voltage regulator circuit 3. The operation of the voltage regulator circuit will be described with reference to FIGS. 5 - 10.

FIGS. 5 - 10 are operation timing diagrams according to various embodiments of the current-controlled voltage regulator circuit of the present disclosure. For convenience of description, a state in which only the distribution resistor strings 430 and 530 are connected between one end of a pass transistor (e.g., the pass transistor 420 for the distribution resistor string 430 and the pass transistor 520 for the distribution resistor string 530) and a ground node (e.g., the node N3 for the distribution resistor string 430 and the node N6 for the distribution resistor string 530) will be referred to as a basic state. FIG. 5 is an operation timing diagram of a current-controlled voltage regulator circuit according to the first embodiment of the present disclosure.

Referring to FIG. 5, the voltage regulator circuit 3 initially operates in the low-power mode, and the timing control logic 30 enables a third control signal LP Regulator Current Control 3 (e.g., third control signal control3 described in FIG. 4) at a time point t1. For example, by transmitting the third control signal control3 in an enable state to the second variable resistor string 540, the third control signal control3 turns on the second variable resistor string 540 so that the total synthesis resistance value of the low-power module 500 decreases. When the second variable resistor string 540 is connected between the node N4 and the node N6 in accordance with the third control signal Control 3 (e.g., an enable state of the third control signal control3), the synthesis resistance value of the low-power module 500 decreases and thus a low-power static current generated in the low-power module 500 increases (LP Boost).

When the high-speed enable signal HS Enable is switched from the disable state to the enable state (e.g., at time point t2), the timing control logic 30 disables the third control signal Control 3 and then enables the first control signal HS Regulator Current Control 1 (e.g., first control signal control1 described in FIG. 4). The HS enable operation blocks 600 starts to generate the HS data at time point t2. For example, by transmitting the first control signal control1 in an enable state to the first variable resistor string 440, the first control signal control1 turns on the first variable resistor string 440 so that the total synthesis resistance value of the high-speed module 400 decreases. In the high-speed module 400, when the first variable resistor string 440 is connected between the node N1 and the node N3 in accordance with the first control signal Control 1 (e.g., an enable state of the first control signal control1), the synthesis resistance value of the high-speed module 400 decreases, and thus the high-speed static current HS Regulator Current generated in the high-speed module 400 increases (HS Boost).

The timing control logic 30 enables the first control signal HS Regulator Current Control 1 (e.g., first control signal control1) for a preset time, and then, when the preset time elapses, enables the high-speed driver 460 through a HS driver enable signal while disabling the first control signal HS Regulator Current Control 1 (e.g., time point t3). The voltage regulator circuit 3 operates in the high-speed mode in accordance with an activation of the high-speed driver enable signal HS Driver Enable and an inactivation of the low-speed driver enable signal LP driver enable (e.g., an enable state of the high-speed driver enable signal HS Driver Enable), which is enabled at t3. The high-speed mode HS Mode includes a preamble period, a synchronization period, a packet data transmission period, and a post-sequence period. For example, when the high-speed driver enable signal HS Driver Enable is enabled at t3, a preamble operation for restoring clocks starts. During the preamble period t3-t4, the high-speed driver 460 more stably generates the high-speed output voltage VOUT_H in accordance with the static current boosted at the previous period t2-t3.

When the transmission of packet data is completed (time point t6), the timing control logic 30 prepares for a low-power mode by enabling the third control signal LP Regulator Current Control 3 during the post-sequence period (time point t6-t7). When the second variable resistor string 540 is connected between the node N4 and the node N6 in accordance with the third control signal Control 3 (e.g., an enable state of the third control signal control3), the synthesis resistance value of the low-power module 500 decreases, and thus the low-power static current LP Regulator Current generated in the low-power module 500 increases (LP Boost). For example, as illustrated and described relative to FIG. 4, during the post-sequence period (time point t6-t7), the third control signal control3 is transmitted to the second variable resistor string 540, which turns on the second variable resistor string 540 (e.g., by decreasing a resistance value, thus resulting in a larger current) so that the total synthesis resistance value of the low-power module 500 decreases, and the static current between nodes N4 and N6 increases, thus facilitating the LP boost indicated in FIG. 5 between t6and t7.

When the post-sequence period is completed (t7), the voltage regulator circuit 3 is switched from the high-speed mode (HS Mode) to the low-power mode (LP Mode). The timing control logic 30 disables the high-speed driver enable signal HS Driver Enable, and the voltage regulator circuit 3 is switched to the low-power mode (LP Mode). The low-power module 500 more stably generates the low-power output voltage VOUT_L in accordance with the low-power static current boosted at the period t6-t7.

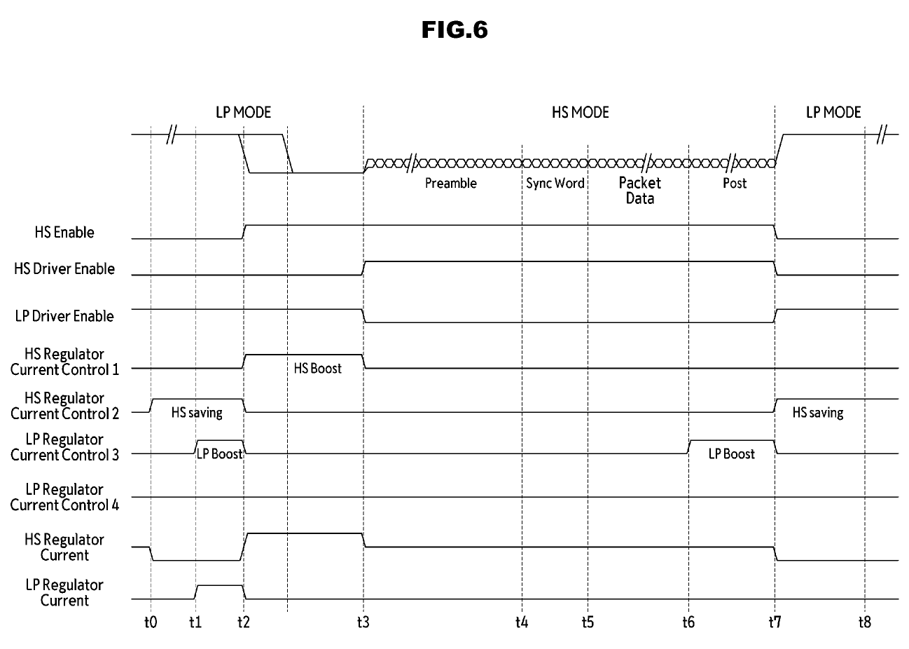

FIG. 6 is an operation timing diagram of a current-controlled voltage regulator circuit according to the second embodiment of the present disclosure.

Referring to FIG. 6, the voltage regulator circuit 3 may reduce the high-speed static current at a period at which the high-speed static current HS Regulator Current is not boosted in the low-power mode unlike FIG. 5.

For example, in the low-power mode, the timing control logic 30 enables the second control signal HS Regulator Current Control 2 (e.g., second control signal control2 illustrated and described in FIG. 4) at time point t0. The high-speed module 400 of the voltage regulator circuit 3 may turn off at least two or more of a plurality of resistors included in the distribution resistor string 430 and the first variable resistor string 440 in accordance with the second control signal Control 2 (e.g., an enable state of the second control signal control2). For example, as illustrated in FIG. 4, the second control signal control2 is transmitted to the distribution resistor string 430 and the first variable resistor string 440, which causes the first variable resistor string 440 to be turned off, and causes at least one of the resistors in the distribution resistor string 430 to be turned off (e.g., the distribution resistor string 430 may include transistors, which can be turned on or off depending on the state of the second control signal HS Regulator Current Control 2). Due to the resistors being turned off, a total synthesis resistance value of the distribution resistor string 430 and the first variable resistor string 440 increases, and thus the high-speed static current flowing from the node N1 to the node N3 is reduced (HS Saving). For example, the high-speed static current HS Regulator Current generated in the high-speed module 400 is further reduced compared to the high-speed basic state. As a result, the high-speed module 400 may reduce power consumption, which may reduce waste when the high-speed module 400 does not operate in the high-speed mode.

The timing control logic 30 enables the third control signal LP Regulator Current Control 3 at a time point t1. The second control signal HS Regulator Current Control 2 and the third control signal Control 3 may be simultaneously enabled during a partial period, for example, between t1 and t2. When the second variable resistor string 540 is connected between the node N4 and the node N6 in accordance with the third control signal Control 3 (e.g., an enable state of the third control signal control3), the synthesis resistance value of the low-power module 500 decreases, and thus the low-power static current LP Regulator Current generated in the low-power module 500 increases (LP Boost).

When the high-speed enable signal HS Enable is switched from the disable state to the enable state (time point t2), the timing control logic 30 disables the second control signal Control 2 and the third control signal Control 3, and then enables the first control signal HS Regulator Current Control 1. The HS enable operation blocks 600 starts to generate the HS data at time point t2. In the high-speed module 400, when the first variable resistor string 440 is connected between the node N1 and the node N3 in accordance with the first control signal Control 1 (e.g., an enable state of the first control signal control1), the high-speed static current HS Regulator Current generated in the high-speed module 400 increases (HS Boost).

The timing control logic 30 enables the first control signal Control 1 for a preset time beginning at t2, and then, when the preset time elapses at t3, enables the high-speed driver 460 (e.g., HS Driver Enable) while disabling the first control signal (time point t3). The voltage regulator circuit 3 operates in the high-speed mode in accordance with the high-speed driver enable signal HS Driver Enable being enabled at t3. When the high-speed driver enable signal HS Driver Enable is enabled and the low-speed driver enable signal LP Driver enable is disable, the high-speed module 400 performs a preamble operation for restoring clocks and the low-speed module 500 turns off. During the preamble period t3-t4, the high-speed driver 460 more stably generates the high-speed output voltage VOUT_H in accordance with the static current boosted at the previous period t2-t3.

When the transmission of packet data is completed (time point t6), the timing control logic 30 prepares for a low-power mode by enabling the third control signal LP Regulator Current Control 3 during the post-sequence period (time point t6-t7). When the second variable resistor string 540 is connected between the node N4 and the node N6 in accordance with the third control signal Control 3 (e.g., an enable state of the third control signal control3), the synthesis resistance value of the low-power module 500 decreases, and thus the low-power static current LP Regulator Current generated in the low-power module 500 increases (LP Boost). For example, as illustrated and described relative to FIG. 4, during the post-sequence period (time point t6-t7), the third control signal control3 is transmitted to the second variable resistor string 540, which turns on the second variable resistor string 540 so that the total synthesis resistance value of the low-power module 500 decreases, and the static current between nodes N4 and N6 increases, thus facilitating the LP boost indicated in FIG. 6 between t6 and t7.

When the post-sequence period is completed based on the high-speed enable signal HS Enable and the high-speed driver enable signal HS Driver Enable (t7), the voltage regulator circuit 3 is switched from the high-speed mode (HS Mode) to the low-power mode (LP Mode). The low-power module 500 more stably generates the low-power output voltage VOUT_L in accordance with the low-power static current boosted at the period t6-t7.

The timing control logic 30 enables the second control signal HS Regulator Current Control 2 (time point t7). When the high-speed driver enable signal transitions to a disable state and the low-speed driver enable signal transitions to a enable state at time point t7, the low-speed module 500 turns on and the high-speed module 400 of the voltage regulator circuit 3 may turn off at least two or more of a plurality of resistors included in the distribution resistor string 430 and the first variable resistor string 440 in accordance with the second control signal HS Regulator Current Control 2 (e.g., an enable state of the second control signal control2). Due to the resistors being turned off, the total synthesis resistance value of the distribution resistor string 430 and the first variable resistor string 440 increases, and thus the high-speed static current flowing from the node N1 to the node N3 decreases (HS Saving).

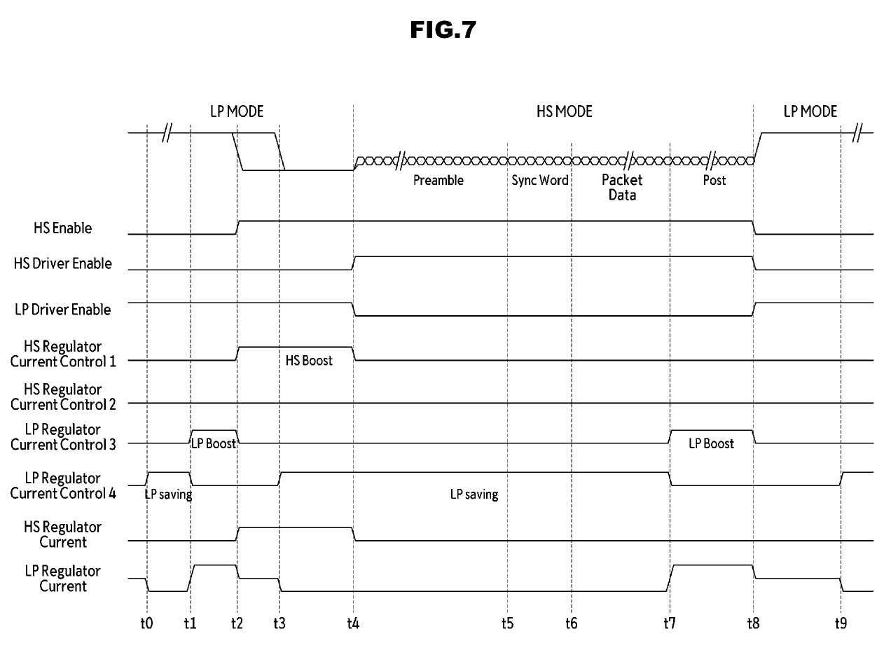

FIG. 7 is an operation timing diagram of a current-controlled voltage regulator circuit according to the third embodiment of the present disclosure.

Referring to FIG. 7, the voltage regulator circuit 3 may reduce the low-power static current at a period other than a low-power boosting period in the low-power mode unlike FIG. 6.

For example, in the low-power mode LP Mode, the timing control logic 30 enables the fourth control signal LP Regulator Current Control 4 (e.g., fourth control signal control4 illustrated and described in FIG. 4) at time point t0. The low-power module 500 of the voltage regulator circuit 3 may turn off at least two or more of a plurality of resistors included in the distribution resistor string 530 may turn off the second variable resistor string 540 in accordance with the fourth control signal (e.g., an enable state of the fourth control signal). Due to the resistors being turned off, a total synthesis resistance value of the distribution resistor string 530 and the second variable resistor string 540 increases, and thus the low-power static current flowing from the node N4 to the node N6 is reduced (LP Saving). For example, the low-power static current LP Regulator Current generated in the low-power module 500 is further reduced compared to the low-power basic state. As a result, the low-power module 500 may reduce power consumption, which may reduce waste during a period at which the low-power module 500 does not operate in the low-power mode or the low-power static current is not boosted.

The timing control logic 30 enables the third control signal LP Regulator Current Control 3 at a time point t1. When the second variable resistor string 540 is connected between the node N4 and the node N6 in accordance with the third control signal Control 3 (e.g., an enable state of the third control signal control3), the synthesis resistance value of the low-power module 500 decreases, and thus the low-power static current LP Regulator Current generated in the low-power module 500 increases (LP Boost). A static current LP i_load (LP Regulator Current) provided to the low-power driver 560 has a low current level at a period t0-t1 due to the fourth control signal being enabled, and has a current level boosted at a periodt1-t2due to the third control signal being enabled. The static current LP i_load (LP Regulator Current) is provided to the distribution resistor string 530 during a period t2-t3, and thus has a basic state of the low-power module 500, for example, a basic static current level.

When the high-speed enable signal HS Enable is switched from the disable state to the enable state (time point t2), the timing control logic 30 disables the third control signal Control 3 and then enables the first control signal Control 1. The HS enable operation blocks 600 starts to generate the HS data at time point t2. The high-speed module 400 increases a high-speed static current corresponding to the high-speed enable signal HS Enable. For example, when the first variable resistor string 440 is connected between the node N1 and the node N3 in accordance with the first control signal Control 1 (e.g., an enable state of the first control signal control1), the high-speed static current HS Regulator Current generated in the high-speed module 400 increases (HS Boost).

The timing control logic 30 enables the third control signal Control 3, which is disabled after boosting of the low-power static current from t1 to t2, after switching to a high-speed mode. For example, the timing control logic 30 enables the third control signal Control 3 for a period (e.g., from t7 to t8) at which the low-power module 500 does not operate, and thus saves the static current applied to the low-power driver 560 (LP Saving). Referring to the shown graph, the low-power static current, which is reduced at the time point t3, falls to a lower level at the time point t3-t7 in accordance with the third control signal (e.g., an enable state of the third control signal control3).

When the high-speed enable signal HS Enable is enabled (time point t2), the timing control logic 30 enables the high-speed driver 460 while disabling the third control signal. When the high-speed driver enable signal HS Driver Enable is enabled (time point t4), the high-speed module 400 performs a preamble operation for restoring clocks to operate in the high-speed mode. During the preamble period t4-t5, the high-speed driver 460 more stably generates the high-speed output voltage VOUT_H in accordance with the static current boosted at the previous period t2-t4.

When the transmission of packet data is completed (time point t7), the timing control logic 30 prepares for a low-power mode by enabling the third control signal LP Regulator Current Control 3 for the post-sequence period (time point t7-t8). When the second variable resistor string 540 is connected between the node N4 and the node N6 in accordance with the third control signal Control 3 (e.g., an enable state of the third control signal control3), the synthesis resistance value of the low-power module 500 decreases, and thus the low-power static current LP Regulator Current generated in the low-power module 500 increases (LP Boost).

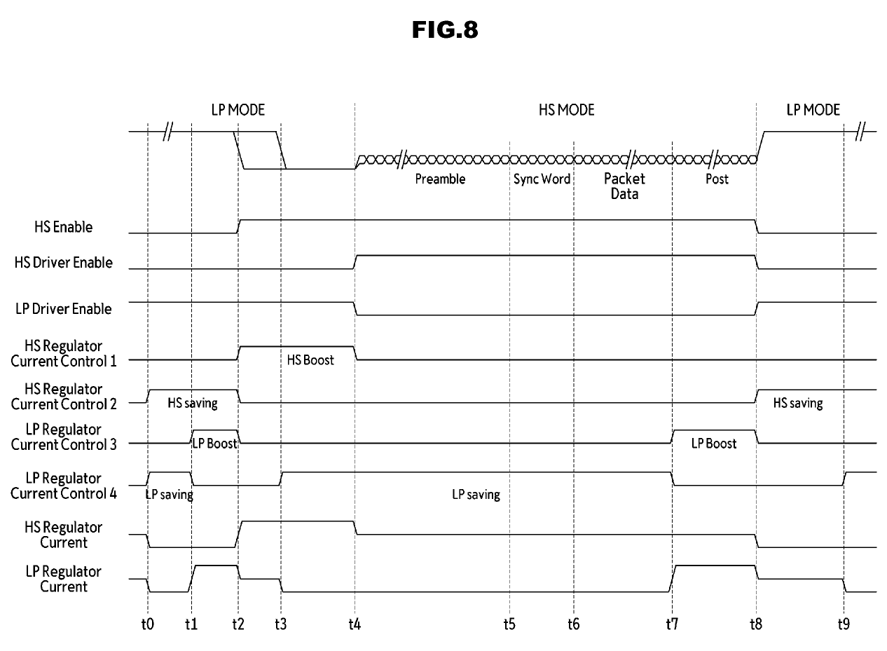

FIG. 8 is an operation timing diagram of a current-controlled voltage regulator circuit according to the fourth embodiment of the present disclosure.

Referring to FIG. 8, the present embodiment includes a configuration in which both static current boost and saving operations are applied to the high-speed module 400 and the low-power module 500. Accordingly, operational stability and power consumption savings may be simultaneously achieved in each of the high-speed mode and the low-power mode.

In the low-power mode LP Mode, the timing control logic 30 in the voltage regulator circuit 3 enables the second control signal HS Regulator Current Control 2 and the fourth control signal LP Regulator Current Control 4 at the time point t0-t1. A saving operation in which the level of the high-speed static current and the level of the low-power static current are reduced compared to the basic state (the level before t0) occurs in accordance with the second control signal Control 2 and the fourth control signal Current Control 4 (HS Saving, LP Saving). For example, the second control signal HS Regulator Current Control 2 may cause an increase in the synthesis resistance value of the high-speed module 400, which causes a decrease in the high-speed static current in the high-speed module 400, and, simultaneously, the fourth control signal LP Regulator Current Control 4 may cause an increase in the synthesis resistance value of the low-power module 500, which causes a decrease in the low-power static current in the low-power module 500.

The timing control logic 30 enables the third control signal LP Regulator Current Control 3 at a time point t1-t2. The low-power static current LP Regulator Current generated in the low-power module 500 increases in accordance with the third control signal (LP Boost).

When the high-speed enable signal HS Enable is switched from the disable state to the enable state at the time point t2, the timing control logic 30 disables the third control signal Control 3 and then enables the first control signal HS Regulator Current Control 1. The HS enable operation blocks 600 starts to generate the HS data at time point t2. Since the first variable resistor string 440 is connected within the high-speed module 400 in accordance with the first control signal Control 1 (e.g., an enable state of the first control signal control1), the high-speed static current HS Regulator Current increases (HS Boost).

When the high-speed driver enable signal HS Driver Enable is enabled at the time point t4, the first control signal HS Regulator Current Control 1 is disabled, so that the high-speed static current HS Regulator Current is reduced at t4 and becomes the current level according to the basic state of the high-speed module 400. During the preamble period t4-t5, the high-speed driver 460 more stably generates the high-speed output voltage VOUT_H in accordance with the static current boosted at the previous period t2-t4.

While the high-speed enable signal HS Enable is enabled at the time point t3, the timing control logic 30 may enable the fourth control signal LP Regulator Current Control 4 regardless of the state of the high-speed driver enable signal HS Driver Enable. Since the total synthesis resistance value of the low-power module 500 increases in accordance with the fourth control signal (e.g., an enable state of the fourth control signal control4), the low-power module 500 may limit the low-power static current LP Regulator Current (LP Saving).

When the transmission of packet data is completed (time point t7), the timing control logic 30 prepares for the low-power mode by enabling the third control signal LP Regulator Current Control 3 for the post-sequence period (time point t7-t8). Since the synthesis resistance value of the low-power module 500 decreases in response to the third control signal LP Regulator Current Control 3 being enabled at t7, the low-power static current LP Regulator Current generated in the low-power module 500 increases (LP Boost).

When the high-speed enable signal HS Enable is switched from the enable state to the disable state at the time point t8, the timing control logic 30 may enable the second control signal control 2 to increase the total synthesis resistance value of the high-speed module 400, thereby limiting the high-speed static current (HS Saving). The HS enable signal may transit from an activating state to a non-activating state, the HS enable operation blocks 600 stops to generate the HS data,

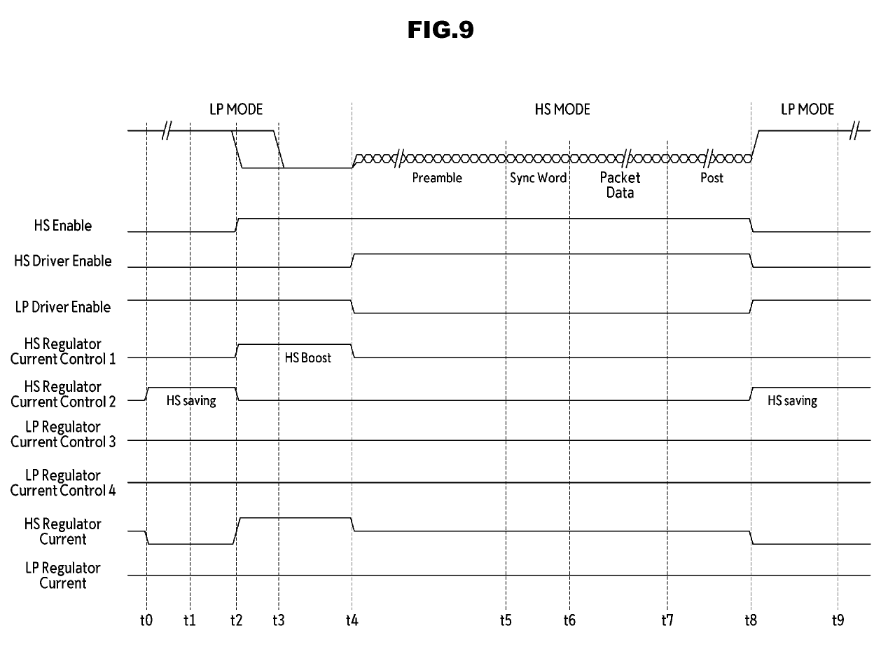

FIG. 9 is an operation timing diagram of a current-controlled voltage regulator circuit according to the fifth embodiment of the present disclosure.

The embodiment in FIG. 9 illustrates a case in which a voltage regulator circuit of a single mode (e.g., high-speed mode in FIG. 9), and not a dual mode, is implemented as shown in FIGS. 2 or 3.

In the low-power mode LP Mode, the timing control logic 30 in the voltage regulator circuit 3 enables the second control signal HS Regulator Current Control 2 at the time point t0-t2. A saving operation in which the level of the high-speed static current HS Regulator Current is reduced compared to the basic state (the level before t0) occurs in accordance with the second control signal Control 2 (HS Saving).

When the high-speed enable signal HS Enable is switched from the disable state to the enable state at the time point t2, the timing control logic 30 enables the first control signal HS Regulator Current Control 1 after disabling the second control signal Control 2. The HS enable operation blocks 600 starts to generate the HS data at time point t2. Since the first variable resistor string 440 is connected in the high-speed module 400 in accordance with the first control signal Control 1 (e.g., an enable state of the first control signal control1), the level of the high-speed static current HS Regulator Current increases (HS Boost).

When the high-speed driver enable signal HS Driver Enable is enabled at the time point t4, the first control signal HS Regulator Current Control 1 is disabled, so that the high-speed static current HS Regulator Current becomes the current level according to the basic state of the high-speed module 400. During the preamble period t4-t5, the high-speed driver 460 more stably generates the high-speed output voltage VOUT_H in accordance with the static current boosted at the previous period t2-t4.

When the transmission of packet data is completed at t7 and the post-sequence period is also terminated (time point t8), the high-speed enable signal HS enable and the high-speed driver enable signal HS Driver Enable are disabled. Accordingly, beginning at t8, the HS enable signal may transit from an activating state to a non-activating state, the HS enable operation blocks 600 stops to generate the HS data. The second control signal HS Regulator Current Control 2 may be enabled to reduce the level of the high-speed static current HS Regulator Current from an operation period of the low-power mode LP Mode not the high-speed mode, thereby limiting the high-speed static current LP Regulator Current input to the high-speed driver 460 (HS Saving).

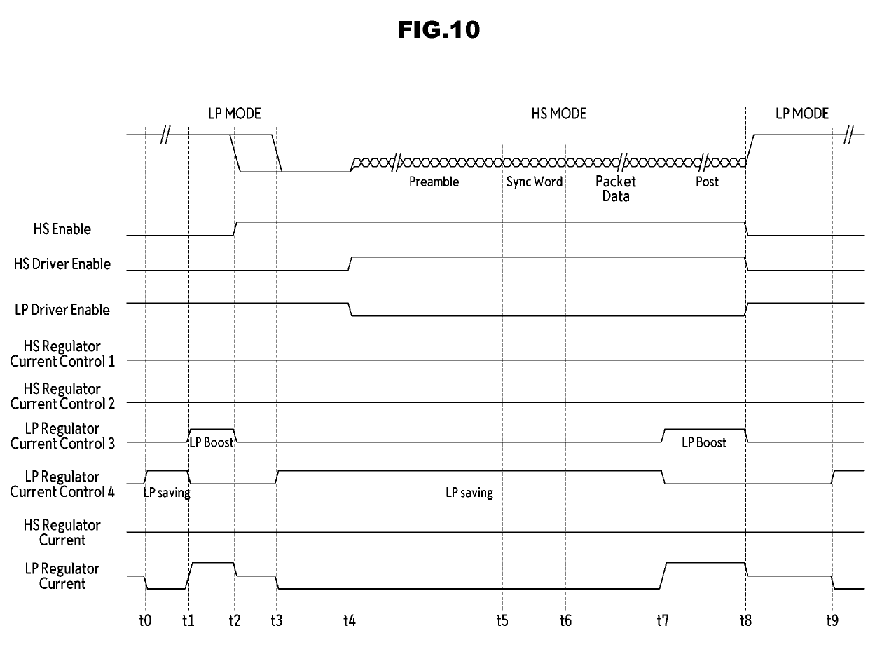

FIG. 10 is an operation timing diagram of a current-controlled voltage regulator circuit according to the sixth embodiment of the present disclosure.

The embodiment in FIG. 10 illustrates a case in which a voltage regulator circuit of a single mode (e.g., low-power mode in FIG. 10), and not a dual mode, is implemented as shown in FIGS. 2 or 3.

In the low-power mode LP Mode, the timing control logic 30 in the voltage regulator circuit 3 enables the fourth control signal LP Regulator Current Control 4 at the time point t0-t1. A saving operation in which the level of the low-power static current LP Regulator Current is reduced compared to the basic state (the level before t0) occurs in accordance with the fourth control signal Control 4 (HS Saving).

The timing control logic 30 enables the third control signal LP Regulator Current Control 3 at the time point t1-t2. The low-power static current LP Regulator current generated in the low-power module 500 increases at t1 in accordance with the third control signal (LP Boost).

When the high-speed enable signal HS Enable is switched from the disable state to the enable state at the time point t2, the timing control logic 30 disables the third control signal Control 3. The HS enable operation blocks 600 starts to generate the HS data at time point t2.

While the high-speed enable signal HS Enable remains enabled at the time point t3, the timing control logic 30 may enable the fourth control signal LP Regulator Current Control 4 regardless of the state of the high-speed driver enable signal HS Driver Enable. The low-power module 500 may limit the low-power static current LP Regulator Current by increasing the synthesis resistance value of the low-power module 500 in accordance with the fourth control signal (LP Saving).

When the transmission of packet data is completed (time point t7), the timing control logic 30 prepares for a low-power mode by enabling the third control signal LP Regulator Current Control 3 and disabling the fourth control signal Control 4 for the post-sequence period (period t7-t8). Since the synthesis resistance value of the low-power module 500 decreases, the low-power static current LP Regulator Current generated in the low-power module 500 increases (LP Boost). However, when the high-speed enable signal and the high-speed driver enable signal are disabled at the time point t8, the third control signal Control 3 is disabled so that the level of the low-power static current is further reduced compared to the basic state. The HS enable operation blocks 600 stops to generate the HS data at time point t8.

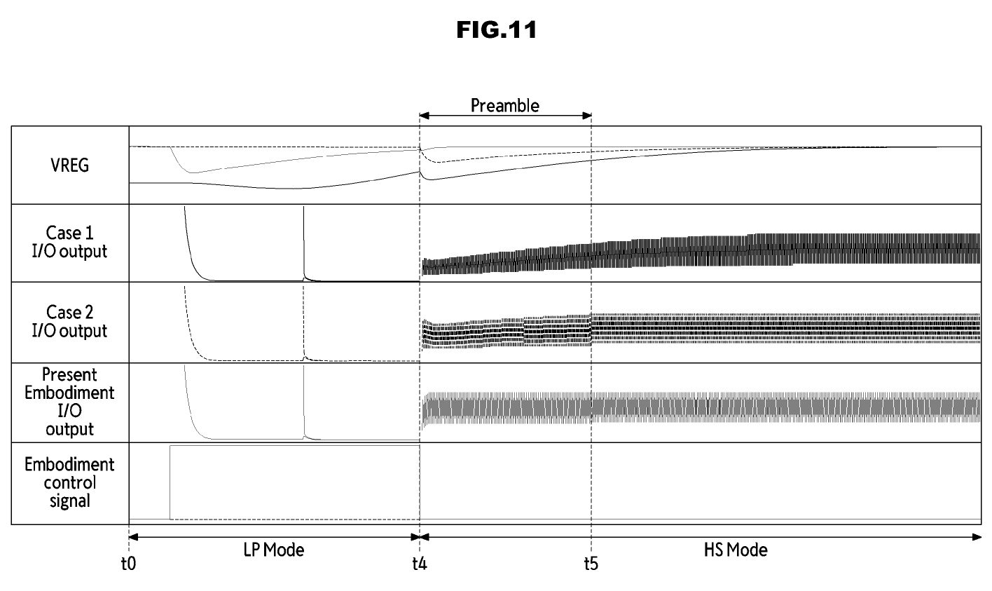

FIG. 11 is a diagram illustrating a voltage graph according to operations of a current-controlled voltage regulator circuit of the present disclosure and a current-controlled voltage regulator circuit of comparative examples.

Referring to FIG. 11, the operation of the current-controlled voltage regulator circuit according to the embodiments of the present disclosure at the preamble period t4-t5, which is the initial stage of the high-speed mode, maintains a faster and more stable output voltage than the output of the voltage regulator circuit of comparative examples (Case 1 and Case 2).

For example, at the preamble period, fluctuation of the output voltage of the regulator circuit is uniform.

An aspect of the present disclosure, a method of operating a current-controlled voltage regulator circuit of an image sensor, the method comprises enabling one of a low-power module in a low-power mode or a high-speed module in a high-speed mode, in response to enabling the low-power module, outputting a first output voltage by the low-power module, in response to enabling the high-speed module in response to an enable state of a high-speed enable signal, outputting a second output voltage based on a high-speed driver enable signal by the high-speed module, wherein the second output voltage is outputted by: boosting a high-speed static current of the high-speed module while the high-speed enable signal is enabled and before the high-speed driver enable signal is enabled and generating the second output voltage based on the boosted high-speed static current when the high-speed driver enable signal is enabled.

The second output voltage is outputted by limiting a level of the high-speed static current before the high-speed enable signal is enabled.

The first output voltage is generated by boosting a low-power static current of the low-power module in the low-power mode before the high-speed enable signal is enabled.

The first output voltage is generated by limiting a level of the low-power static current during a period that does not overlap a period in which the low-power static current is boosted in the low-power mode.

Although the embodiments of the present disclosure have been described with reference to the accompanying drawings, it will be apparent to those skilled in the art that the present disclosure can be manufactured in various forms without being limited to the above- described embodiments and can be embodied in other specific forms without departing from the technical spirits and essential characteristics. Thus, the above embodiments are to be considered in all respects as illustrative and not restrictive.

What is claimed is:

1. A current-controlled voltage regulator circuit of an image sensor, the current-controlled voltage regulator circuit comprising:
a low-power module configured to be enabled in a low-power mode and to output a first output voltage; and
a high-speed module configured to be enabled in a high-speed mode in response to an enable state of a high-speed enable signal, and output a second output voltage based on a high-speed driver enable signal,
wherein the current-controlled voltage regulator circuit is configured to:
boost a high-speed static current of the high-speed module while the high-speed enable signal is enabled and before the high-speed driver enable signal is enabled, and
generate the second output voltage based on the boosted high-speed static current when the high-speed driver enable signal is enabled.

2. The current-controlled voltage regulator circuit of claim 1, wherein the current-controlled voltage regulator circuit is configured to generate the second output voltage by limiting a level of the high-speed static current before the high-speed enable signal is enabled.

3. The current-controlled voltage regulator circuit of claim 1, wherein the current-controlled voltage regulator circuit is configured to generate the first output voltage by boosting a low-power static current of the low-power module in the low-power mode before the high-speed enable signal is enabled.

4. The current-controlled voltage regulator circuit of claim 3, wherein the current-controlled voltage regulator circuit is configured to generate the first output voltage by limiting a level of the low-power static current during a period that does not overlap a period in which the low-power static current is boosted in the low-power mode.

5. The current-controlled voltage regulator circuit of claim 1, wherein the high-speed module includes:
a first operational amplifier configured to receive a first reference voltage and a first feedback signal;
a first pass transistor connected between a power voltage terminal and a first node and a gate of the first pass transistor is connected to an output of the first operational amplifier;
a first distribution resistor string connected between the first node and a ground node;
a first variable resistor string connected in parallel with the first distribution resistor string and configured to conduct a current between the first node and the ground node when a first control signal is enabled; and
a driver circuit connected to the first node and configured to generate the first output voltage based on the high-speed static current,
wherein the current-controlled voltage regulator circuit
operates in the high-speed mode when the high-speed enable signal is disabled, and
the first feedback signal is a signal of a first common node of the first distribution resistor string and the first variable resistor string.

6. The current-controlled voltage regulator circuit of claim 5, wherein the current-controlled voltage regulator circuit is configured to turn off the first variable resistor string of the high-speed module and is configured to turn off at least one of a plurality of resistors included in the first distribution resistor string when a second control signal is enabled.

7. The current-controlled voltage regulator circuit of claim 5, wherein the low-power module includes:
a second operational amplifier configured to receive a second reference voltage and a second feedback signal;
a second pass transistor connected between a power voltage terminal and a second node, a gate of the second pass transistor connected to an output of the second operational amplifier;
a second distribution resistor string connected between the second node and a ground node;
a second variable resistor string connected in parallel with the second distribution resistor string and configured to conduct a current between the second node and the ground node when a third control signal is enabled; and
a second driver circuit connected to the second node and configured to generate the second output voltage based on the low-power static current, and
wherein the second feedback signal is a signal of a second common node of the second distribution resistor string and the second variable resistor string.

8. The current-controlled voltage regulator circuit of claim 7, wherein the current-controlled voltage regulator circuit is configured to turn off the second variable resistor string of the low-power module and is configured to turn off at least one of a plurality of resistors included in the second distribution resistor string when a fourth control signal is enabled.

9. A current-controlled voltage regulator circuit of an image sensor, the current-controlled voltage regulator circuit comprising:
an operational amplifier configured to receive a reference voltage and a feedback signal;
a pass transistor connected between a power voltage terminal and a first node and a gate connected to an output of the operational amplifier;
a distribution resistor string connected between the first node and a ground node;
a first variable resistor string connected in parallel with the distribution resistor string and configured to conduct a current between the first node and the ground node when a first control signal is enabled;
a driver circuit connected to the first node and configured to generate an output voltage based on a static current of the first node; and
a timing controller configured to generate the first control signal and a second control signal,
wherein the feedback signal is a signal of a common node connected to a first intermediate node of the distribution resistor string and a second intermediate node of the first variable resistor string, and
wherein the timing controller is configured to boost the static current of the first node by enabling the first control signal while a high-speed enable signal is enabled and before a high-speed driver enable signal is enabled.

10. The current-controlled voltage regulator circuit of claim 9, wherein the timing controller is configured to turn off the first variable resistor string and is configured to turn off at least one of a plurality of resistors included in the distribution resistor string before the high-speed enable signal is enabled.

11. The current-controlled voltage regulator circuit of claim 9, wherein the first control signal is not enabled simultaneously with the second control signal.

12. An image sensing device comprising:
a pixel array including a plurality of pixels to output a pixel value sensed from each of the pixels;
an ADC circuit configured to perform analog-to-digital conversion for the pixel value;
a buffer configured to store the analog-to-digital converted pixel value; and
an input/output circuit including a current-controlled voltage regulator circuit, configured to generate an output voltage by comparing a reference voltage with a feedback signal, and configured to generate image data with the output voltage applied to a raw image including the analog-to-digital converted pixel value stored in the buffer to output the image data,
wherein a high-speed static current of the current-controlled voltage regulator circuit is configured to be boosted while a high-speed enable signal is enabled and before a high-speed driver enable signal is enabled, and a high-speed regulating voltage generated by the current-controlled voltage regulator circuit is output as the output voltage based on the boosted high-speed static current when the high-speed driver enable signal is enabled.

13. The image sensing device of claim 12, wherein the current-controlled voltage regulator circuit includes a high-speed module and a low-power module,
the high-speed module includes:
a first operational amplifier configured to receive a first reference voltage and a first feedback signal;
a first pass transistor connected between a power voltage terminal and a first node, a gate of the first pass transistor connected to an output of the first operational amplifier, , so that a high-speed regulating voltage is configured to be generated at the first node;
a first distribution resistor string connected between the first node and a ground node;
a first variable resistor string connected in parallel with the first distribution resistor string and configured to conduct a current between the first node and the ground node when a first control signal is enabled; and
a first driver circuit connected to the first node and configured to generate the high-speed regulating voltage or a power voltage as a high-speed output voltage in response to the high-speed driver enable signal, and the first driver circuit is configured to output the high-speed output voltage as the output voltage, and
wherein the first feedback signal is a signal of a first common node connected to a first intermediate node of the first distribution resistor string and a second intermediate node of the first variable resistor string.

14. The image sensing device of claim 13, wherein the first variable resistor string of the high-speed module is configured to be turned off and at least one of a plurality of resistors included in the first distribution resistor string is configured to be turned off when a second control signal is enabled.

15. The image sensing device of claim 13, wherein the low-power module includes:
a second operational amplifier configured to receive a second reference voltage and a second feedback signal;
a second pass transistor connected between a power voltage terminal and a second node, a gate of the second pass transistor connected to an output of the second operational amplifier, so that a low-power regulating voltage is configured to be generated at the second node;
a second distribution resistor string connected between the second node and a ground node;
a second variable resistor string connected in parallel with the second distribution resistor string and configured to conduct a current between the second node and the ground node when a third control signal is enabled; and
a second driver circuit connected to the second node and configured to generate the low-power regulating voltage or a power voltage as a low-power output voltage in response to the high-speed driver enable signal, and the second driver circuit is configured to output the low-power output voltage as the output voltage in response to an enable state of the high-speed enable signal, and
wherein the second feedback signal is a signal of a second common node connected to a third intermediate node of the second distribution resistor string and a fourth intermediate node of the second variable resistor string.

16. The image sensing device of claim 13, wherein, when the high-speed driver enable signal is enabled, the first control signal is configured to be disabled, and the boosting of the high-speed static current is configured to be terminated.

17. The image sensing device of claim 16, wherein a second control signal is enabled before the first control signal is enabled, and a level of the high-speed static current is configured to be limited.

18. The image sensing device of claim 17, wherein a low-power static current generated at the second pass transistor is configured to be boosted while the third control signal is enabled.

19. The image sensing device of claim 18, wherein a fourth control signal is enabled while the high-speed enable signal is enabled and while the third control signal is disabled, and, in response, a level of the low-power static current is configured to be limited.

20. The image sensing device of claim 12, wherein a preamble period, a synchronization period, a packet data transmission period, and a post-sequence period are provided while the high-speed driver enable signal is enabled, and
the current-controlled voltage regulator circuit is configured to limit a level of a low-power static current during the preamble period, the synchronization period and the packet data transmission period, and is configured to boost the low-power static current during the post-sequence period.
